(19) United States
(12) Patent Application Publication
(10) Pub. No.: US 2025/0193496 A1
(43) Pub. Date: Jun. 12, 2025

(54) METHODS AND SYSTEMS FOR STORING CONTENT

(71) Applicant: Comcast Cable Communications, LLC, Philadelphia, PA (US)

(72) Inventors: Gary Michael REKSTAD, JR., Philadelphia, PA (US); Leon VENTON, Philadelphia, PA (US); Benny J. PRUDEN, Brownstown, PA (US); Philip John STROFFOLINO, Media, PA (US); Gagan CHAWLA, Wayne, PA (US)

(21) Appl. No.: 18/537,412

(22) Filed: Dec. 12, 2023

(51) Int. Cl. H04N 21/6587; H04N 21/433; H04N 21/472

(52) U.S. Cl. CPC H04N 21/6587; H04N 21/4331; H04N 21/47217

(57) ABSTRACT

Methods and systems for storing content are disclosed. At least a first portion of a content item may be stored to a first buffer in a first storage located on a computing device. Based on user-initiation of at least one trick play operation, output of the at least the first portion of the content item from the first buffer may be caused. It may be determined that at least an additional portion of the content item is required to perform the trick play operation(s). At least the additional portion of the content item may be received from a second buffer in a second storage located remotely from the computing device. Output of the received additional portion of the content item may be caused.

### BACKGROUND

Users may be able to control the output (e.g., playback) of live content via an output device using time shifting (e.g., trick play) operations, such as seek, pause, rewind, and fast-forward. If a user executes a trick play operation, the output device may switch from outputting the live content to outputting older content stored (e.g., cached) in a buffer. When delays occur between user-execution of the trick play operation and output of content from the newly requested play position, a poor content-viewing experience occurs. This disclosure addresses these and other shortcomings.

### SUMMARY

Systems and methods for storing content are described herein. A portion of a content item may be stored (e.g., cached) in a buffer in a storage that is located remotely from an output device. A viewer of the content item may leverage the portion of content stored in the remote buffer to control (e.g., time shift) the output (e.g., playback) of the content via an output device. However, a delay may occur between the viewer executing a time shifting (e.g., trick play) operation and the output device accessing and delivering the content stored in the remote buffer. The delay may negatively impact the content-viewing experience. To avoid such a delay, a portion of the content item may also be stored (e.g., cached) in a buffer that is located on the output device. The portion of the content item stored in the buffer on the output device may be a smaller portion than the portion stored in the buffer on the remotely located storage. If a viewer executes a time-shift operation, the output device may access and deliver the content stored in the local buffer to provide a near-instantaneous rewind or skip-back experience for the viewer. The output device may access the remote buffer if content beyond the portion stored in the local buffer is needed to continue the trick play operation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an example system.

FIG. 2 is an example system and method.

FIG. 3 is an example process.

FIG. 4 is example method.

FIG. 5 is an example method.

FIG. 6 is an example method.

FIG. 7 is an example computing device.

### DETAILED DESCRIPTION

Time-shift buffers (TSBs) may be used to temporarily store at least a portion of incoming content (e.g., live linear video and/or audio content) so that viewers are able to use time shifting (e.g., trick play) operations, such as pausing the content and/or rewinding the content. A TSB may be implemented in a storage on a server, such as on a cloud server, that is located remotely from the device that is causing output (e.g., playback) of the content. Such a TSB may herein be referred to as a “remote TSB” or a “cloud-based TSB.” If a viewer executes a trick play operation, the output device may switch from outputting the incoming content to outputting the portion of the content that has been stored in the remote (e.g., cloud-based) TSB.

However, remote (e.g., cloud-based) TSBs are associated with various shortcomings. First, a delay (e.g., lag) may occur between the viewer executing a trick play operation and the output device accessing and retrieving the content from the remote (e.g., cloud-based) TSB in order to output the content on the output device for the viewer. The delay may be long enough to negatively impact the content-viewing experience. For example, the delay may be similar to the time needed for a channel change, which can be especially slow for Internet Protocol (IP)-based content viewing. Second, to avoid the need to create and destroy multiple remote (e.g., cloud-based) TSB sessions, the content stored in the remote (e.g., cloud-based) TSB may not be immediately available after a viewer changes the channel. Third, fast forwarding and/or rewinding content in a remote (e.g., cloud-based) TSB may only use I-frames, resulting in a freeze-frame effect. Thus, improved techniques for storing content are desirable.

Described herein are techniques for storing content. A content item may be simultaneously stored to (e.g., recorded to) a TSB in a storage located on the output device (e.g., a local TSB) and to a remote (e.g., cloud-based) TSB. The local TSB may store a first portion (e.g., ten seconds, fifteen seconds, twenty seconds, thirty seconds, etc.) of the content item, and the remote TSB may store at least an additional portion of the content item. That is, a larger portion of the content item may be stored to (e.g., recorded to) the remote TSB than the portion stored to the local TSB.

If the viewer rewinds and/or skips back output of the content item, the output device may output content from the local TSB to provide a near-instantaneous rewind or skip-back experience for the viewer, even immediately after a viewer changes the channel. Further, unlike remote (e.g., cloud-based) TSBs, the local TSB may not be limited to relying on I-frames for performing fast-forwards and rewinds of the content. As such, the local TSB may provide for a smoother output of content than remote (e.g., cloud-based) TSBs. The output device may still rely on the larger portion of the content stored in the remote (e.g., cloud-based) TSB if the viewer rewinds or skips back so far that the portion of the content item stored in the local TSB is not sufficient to perform the rewind or skip back.

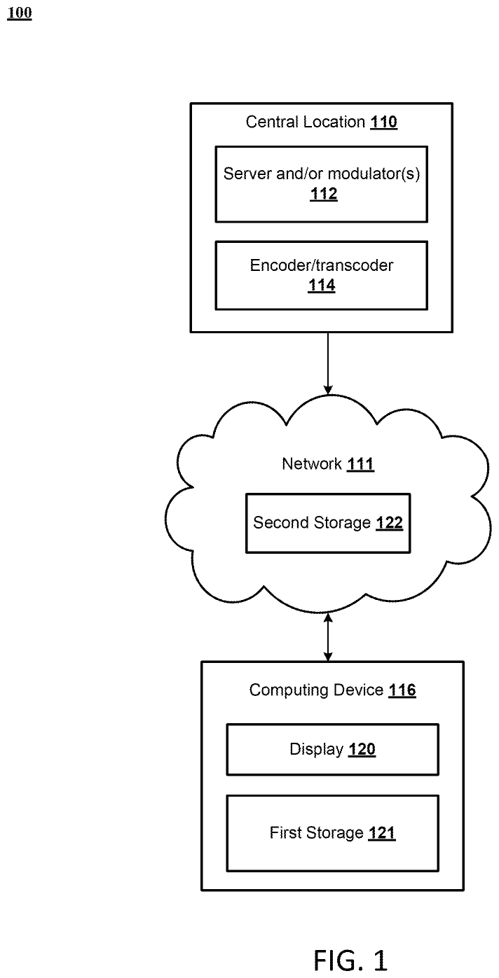

FIG. 1 is an example system 100. The system 100 may be used to store content in both a local TSB and to a remote (e.g., cloud-based) TSB. The system 100 may comprise a central location 110 (e.g., a headend, or processing facility), which may receive content (e.g., data, input programming) from multiple sources. The central location 110 may combine the content from the various sources and may distribute the content to user locations (e.g., device location) via a distribution system and/or network, such as a network 111. The central location 110 may be a data processing facility configured to receive content from a variety of sources.

The content may comprise video and/or audio content. The content may comprise one or more of linear content, non-linear content, video-on-demand (VoD) content, live VoD content, audio content, multi-media content, recorded content, stored content, or any other form of content a user may wish to consume. Video content may refer generally to any video content produced for viewer consumption regardless of the type, format, genre, or delivery method. Video content may comprise video content produced for broadcast via over-the-air radio, cable, satellite, or the internet. Video content may comprise a movie, a television show or program, an episodic or serial television series, or a documentary series, such as a nature documentary series. The content may comprise a song, a television show, a live broadcast, a movie, a podcast, an audio book, or any other type of content a user may wish to consume.

The content may be transmitted from the source to the central location 110 via a variety of transmission paths, including wireless and terrestrial paths. The central location 110 may comprise a plurality of streaming servers and/or signal modulators 112, such as quadrature amplitude modulation (QAM) devices, that may be associated with an input source. The streaming servers and/or signal modulators 112 may transmit, or first convert and then transmit, received content into a modulated output signal suitable for transmission over the network 111. Encoders and/or transcoders, such as an encoder/transcoder 114, may be included for encoding/transcoding data such as content. The encoder/transcoder 114 may comprise an MPEG encoder, an AV1 encoder, a VP9 encoder, and/or any other suitable type of encoder. A data packaging device, such as a fragmentor, may be integrated with the encoder/transcoder 114 (or separate and in communication with the encoder/transcoder 114) to package the encoded/transcoded content. The encoder/transcoder 114 and/or fragmentor may repeatedly embed markers, flags, and signals into the content data stream for processing by downstream devices.

The network 111 may be configured to distribute content from the central location 110 to user and/or device locations, such as a location of a computing device 116. The network 111 may be an optical fiber network, a broadband network, a coaxial cable network, a hybrid fiber-coaxial network, a wireless network, a satellite system, a direct broadcast system, or any combination thereof. There may be a multitude of user locations connected to network 111.

The network 111 may comprise a second storage 122. The second storage 122 may be configured as network storage, such as cloud storage, accessible by one or more computing devices, such as the computing device 116. A number of content items (e.g., video, audio, etc.) may be loaded into the second storage 122 and stored for playback or processing by the computing device 116. However, other data, content, and/or information may be stored in the second storage 122 such as advertisements and alternative content, for example. The second storage 122 may be separate from the network 111. The second storage 122 may be located at multiple locations within the network 111 and/or in any other network. For example, the second storage 122 may be located upstream of the computing device 116 and downstream of the network 111. The second storage 122 may store information, such as content, to be transmitted to the computing device 116 or other recipient devices.

The computing device 116 may receive content from the network 111. The computing device 116 may process the content received from the network 111 with a regular cadence (e.g., every two seconds, four seconds, ten seconds, and the like). Other data and tracks may be received and processed by the computing device 116. The computing device 116 may be configured as a decoder, such as a gateway, set-top box, or communications terminal (CT) to decode, if needed, the signals for display on a display device, such as on a display 120.

The computing device 116 may cause output (e.g., rendering, playback) of the received content from the network 111 via a display 120. The computing device 116 may be a CT, a set-top box, a television, a computer, a smartphone, a laptop, a tablet, a multimedia playback device, a portable electronic device, and/or the like configured to cause output (e.g., playback) of content. The computing device 116 may be an Internet Protocol compatible device for receiving signals via a network such as the Internet or some other communications network for providing content to the user. It is understood that other display devices and networks may be used. The computing device 116 may be a widget or a virtual device for displaying content in a picture-in-picture environment such as via the display 120, for example.

The computing device 116 may comprise a first storage 121. The first storage 121 may comprise, for example, a volatile storage medium. The volatile storage medium may comprise random access memory (RAM) or dynamic RAM (DRAM). Alternatively, the first storage 121 may comprise a non-volatile storage medium such as on hard disc drives (HDDs) or flash memory (e.g., NAND, eMMC, etc.). The first storage 121 may comprise a copy of the operating system (OS) may be loaded onto the first storage 121. The first storage 121 may facilitate local storage of at least a portion (e.g., two seconds or less) of received content for rendering of the content. For example, incoming content may be sent to the first storage 121 to buffer the incoming content to account for network variations and to avoid video freezes. Rendering content may comprise providing audio and/or video, displaying images, facilitating an audio or visual feedback, tactile feedback, and the like. Other data, content, and/or information may be stored in the first storage 121 such as firmware and/or settings data associated with the computing device 116, for example. The first storage 121 may be separate from the computing device 116 and in communication with the computing device 116, such as via a portable flash drive.

The first storage 121 may be used to provide a first buffer, such as a first TSB (e.g., local TSB), for caching a first portion (e.g., a playback duration) of a content item (e.g., live content stream, linear content stream) received from the network 111. The first portion of the content item may be caused to be recorded to the first buffer of the first storage 121 based on the computing device 116 being activated (e.g., turned on, powered on) and/or based on a user associated with the computing device 116 switching to a new channel. The first portion of the content item may comprise any playback duration of the content item, such as ten seconds, fifteen seconds, twenty seconds, thirty seconds, etc. of the content item. The first portion of the content item may be stored to the first buffer in a different section of the first storage 121 than is used to buffer the incoming content for immediate output (i.e., playback) to the user. The stored first portion may be used to provide trick play features during playback of the content item.

The amount of available memory in the first storage 121 may be large enough to hold only a limited playback duration (e.g., 15 seconds, thirty seconds, etc.) of the content item. To write content to the first buffer in the first storage 121, the computing device 116 may repeatedly write over the first portion of the content item stored in the first storage 121 to generate a new first portion of the content item. For example, the first buffer may be implemented as a circular buffer in which content is temporarily stored on a first-in, first-out basis such that the buffered content is continuously replaced over time with newer incoming content. The first buffer, and hence the first portion of the content item stored in the first buffer, of the storage 121 may not be large enough to facilitate a user rewinding all the way back to the beginning of a content item (such as a television show), but the stored first portion of the content item may still be large enough to facilitate quick rewinds and/or skip backs (e.g., to rewatch a play in a sporting event or to try to catch missed dialog).

The second storage 122 associated with the network 111 may be used to provide a second buffer, such as a second TSB (e.g., cloud-based TSB), for caching at least an additional portion (e.g., a longer playback duration) of the same content item. The additional portion(s) of the content item may be caused to be recorded to the second buffer of the second storage 122 based on the computing device 116 being activated (e.g., turned on, powered on) and/or based on a user associated with the computing device 116 switching to a new channel.

The amount of available memory in the second storage 122 may be large enough to hold a larger playback duration (i.e., larger portion), such as ten minutes, thirty minutes, one hour or more of the content item. For example, the amount of available memory in the second storage 122 may be large enough to hold the entire playback duration of the content item. As such, the second buffer in the second storage 122 may store both the first portion of the content item and the additional portion(s) of the content item. The additional portion(s) of the content item may comprise any playback duration of the content item, such as five minutes, ten minutes, thirty minutes, etc. of the content item. The stored additional portion(s) of the content item may be leveraged (e.g., used) to provide trick play features during playback of the content item.

A delay (e.g., lag) may occur between a viewer executing a trick play operation and the computing device 117 accessing and delivering the content stored in the second buffer of the second storage 122. The delay may be long enough to negatively impact the content-viewing experience. For example, the delay may be similar to the time needed for a channel tune, which can be especially slow for Internet Protocol (IP)-based content viewing. To avoid this delay, the first portion of the content item that is stored in the first buffer of the first storage 121 may be leveraged to facilitate quick rewinds and/or skip backs (e.g., to rewatch a play in a sporting event or to try to catch missed dialog). By leveraging the first portion of the content item that is stored in the first buffer of the first storage 121, the computing device 117 may provide a near-instantaneous rewind or skip-back experience for the viewer.

The content that is stored in the second buffer of the second storage 122 may still be leveraged to facilitate longer rewinds and/or skip backs. The computing device 117 may begin requesting content from the second buffer in the second storage 122 based on (e.g., in response to) initiating output of the first portion of the content item from the first buffer. As such, if the viewer rewinds or skips back to a frame of the content item that is not stored in the first buffer, the computing device 117 may be able to output content from the second buffer while avoiding or minimizing the delay that is typically associated with accessing content stored in a remote (e.g., cloud-based) TSB.

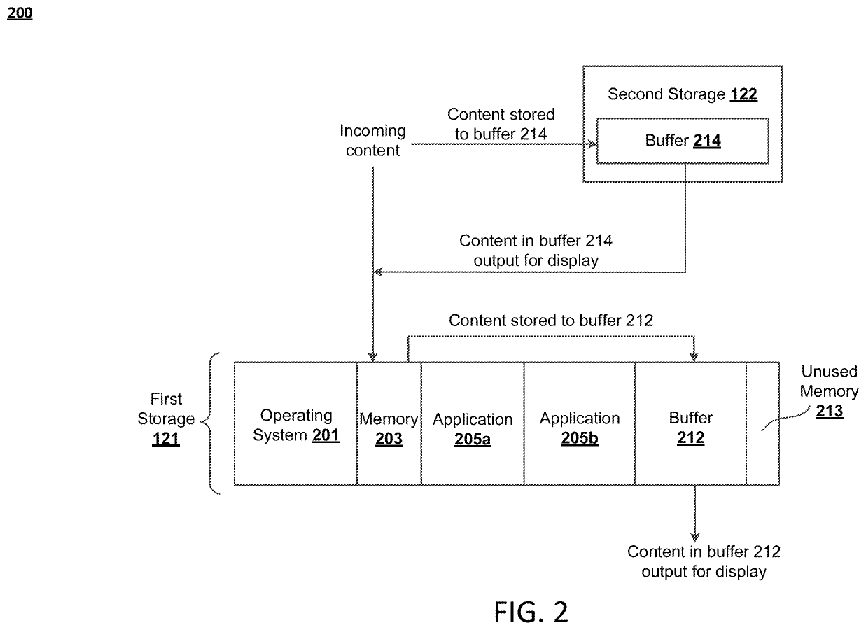

FIG. 2 is an example system 200 and method. The method may be performed by the system 200 to leverage content that is stored in the first buffer of the first storage 121 to facilitate quick rewinds and/or skip backs. The system 200 may comprise the first storage 121 and the second storage 122.

Incoming content may be sent to the first storage 121 (e.g., from the network 111 or another source). The first storage 121 may receive incoming content. The first storage 121 may facilitate local storage of at least a portion (e.g., two seconds) of the incoming content, for processing, e.g., rendering, of the content, in a memory 203. For example, incoming content may be temporarily buffered in the memory 203 to account for network condition variations and to avoid video quality issues, such as freezes. Rendering content may comprise providing audio and/or video, displaying images, facilitating an audio or visual feedback, tactile feedback, and the like. The incoming content that is stored (e.g., temporarily buffered) in the memory 203 may be output for display. At least a portion of the memory in the first storage 121 may be unused (e.g., available) memory 213. The first storage 121 may store a copy 201 of the operating system (OS) of the computing device 117. One or more applications 205a-b may be loaded onto the first storage 121.

The first storage 121 may be used to provide memory to buffer live or time shifted content, such as the first buffer 212, for caching a first portion (e.g., a playback duration) of the incoming content (e.g., live content stream, linear or time-shifted content stream). The incoming content that is stored (e.g., temporarily buffered) in the memory 203 may be stored to (e.g., cached in) the first buffer 212. The first buffer 212 may comprise a TSB. The first buffer 212 may comprise a local TSB. The first portion of the content item may be stored in the first buffer 212 based on the computing device 116 being activated (e.g., turned on, powered on) and/or based on a user associated with the computing device 116 switching to a new channel. The first portion of the content item stored in the first buffer 212 may comprise any playback duration of the content item, such as ten seconds, fifteen seconds, twenty seconds, thirty seconds, etc. of the content item. The stored first portion may be leveraged to provide trick play features during playback of the content item.

As described above, the first buffer 212 in the first storage 121 may hold only a limited playback duration (e.g., fifteen seconds, thirty seconds, etc.) of the content item. If the first buffer 212 is full (e.g., cannot store any more content), the computing device 117 may write over the content item stored in first buffer 212 to generate a new first portion of the content item. For example, if the first buffer 212 is full (e.g., cannot store any more content), the computing device 117 may write over the content item stored in first buffer 212 to generate a new first portion of the content item based on (e.g., in response to determining that) the content stored in the first buffer 212 is not currently being output.

If the first buffer 212 is full (e.g., cannot store any more content) and/or if content is currently being output from the first buffer 212, the computing device 117 may determine if the unused memory 213 comprises a sufficient amount of available memory to expand the first buffer 212. For example, the computing device 117 may try to free up additional memory and increase the first buffer 212 in case the user wishes to skip back or rewind further. If the unused memory 213 comprises a sufficient amount of available memory to expand the first buffer 212, the first buffer 212 may be expanded and additional content may be stored in the expanded first buffer 212.

If the unused memory 213 does not comprise a sufficient amount of available memory to expand the first buffer 212, the computing device 117 may cause the sufficient amount of memory to become available. If the user is actively engaged in viewing the content item, they are not likely to switch to another application. Thus, the computing device 117 may cause the sufficient amount of memory to become available by unloading at least one application 205a-b from the first storage 121. The application(s) may comprise one or more applications that are loaded to the first storage 121 but are not currently in use. Based on unloading the application(s) from first storage 121, additional content may be stored in the expanded first buffer 212. If the expanded first buffer 212 becomes full (e.g., cannot store any more content), the computing device 117 may write over the content item stored in the expanded first buffer 212 to generate a new first portion of the content item.

If the use of and/or the need for the expanded first buffer 212 ends, the application(s) that were unloaded may be reloaded to the first storage 121. The application(s) that were unloaded may be reloaded to the first storage 121 based on (e.g., in response to) determining that the first buffer 212 no longer needs to be expanded. The first buffer 212 may no longer need to be expanded if the user has changed the channel and/or powered off the computing device 117. The first buffer 212 may no longer need to be expanded if the user has fast-forwarded and/or has skipped far enough ahead in the content stream that such that the initial, smaller first buffer 212 is sufficient.

The incoming content may additionally be sent to the second storage 122 (e.g., from the network 111 or another source). The second storage 122 may receive the incoming content. The second storage 122 may be used to provide memory to buffer live or time shifted content, such as the second buffer 214, for caching at least an additional portion (e.g., a longer or longer playback duration) of the incoming content (e.g., live content stream, linear or time-shifted content stream). The second buffer 214 may comprise a TSB. The second buffer 214 may comprise a remote TSB (e.g., cloud-based TSB). The additional portion(s) of the content item may be stored in the second buffer 214 based on the computing device 116 being activated (e.g., turned on, powered on) and/or based on a user associated with the computing device 116 switching to a new channel. The additional portion(s) of the content item stored in the second buffer 214 may comprise any playback duration of the content item, such as 30 minutes, one hour, two hours, four hours, eight hours, etc. of the content item. The first portion of the content item may additionally be stored in the second buffer 214. The content stored in the second buffer 214 may be leveraged to provide trick play features during playback.

As described above, the first portion of the content item stored in the first buffer 212 may be large enough to facilitate quick rewinds and/or skip backs (e.g., to rewatch a play in a sporting event or to try to catch missed dialog). If the viewer initiates a quick rewind or skip-back of the content item (e.g., to a timestamp that is five, ten, fifteen, etc. seconds behind the live-point of incoming the content stream), the first portion of the content item stored in the first buffer 212 may comprise all of the content that is required to perform the rewind or skip-back of the content item (e.g., the content corresponding to the timestamp). The rewind or skip-back may be performed using the first portion of the content item stored in the first buffer 212, and none of the content stored in the second buffer 214. Performing the rewind or skip-back using the first portion of the content item stored in the first buffer 212 may comprise causing output of at least some of the first portion of the content item stored in the first buffer 212. Using the content stored in the first buffer 212 instead of the content stored in the second buffer 214 to perform the rewind or skip-back allows for a near-instantaneous rewind or skip-back experience for the user.

However, as described above, the first buffer 212 in the first storage 121 may hold only a limited playback duration (e.g., 15 seconds, thirty seconds, etc.) of the content item. Thus, while it may be desirable to use the content stored in the first buffer 212 instead of the content stored in the second buffer 214 to perform rewind or skip-back operations, the first buffer 212 may not always contain all of the content required to perform longer rewind or skip-back. For example, if the first buffer 212 in the first storage 121 holds only thirty seconds of the content item, and the user rewinds or skip-backs 45 seconds, the first buffer 212 may not contain fifteen seconds of content required to perform the rewind or skip-back.

If the first buffer 212 does not contain all of the content required to perform the rewind or skip-back, the longer rewind or skip-back may be performed using only the content stored in the second buffer 214 and none of the content stored in the first buffer 212. Performing the longer rewind or skip-back using only the content stored in the second buffer 214 may comprise causing output of at least a portion of the content stored in the second buffer 214.

If the first buffer 212 does not contain all of the content required to perform the rewind or skip-back, the longer rewind or skip-back may be performed using a combination of the content stored in the first buffer 212 and the second buffer 214. Performing the longer rewind or skip-back using a combination of the content stored in the second buffer 214 and the content stored in the first buffer may comprise causing output of at least a portion of the content stored in the second buffer 214 and at least a portion of the content stored in the first buffer 212. The computing device 117 may begin requesting content from the second buffer 214 based on (e.g., in response to) initiating output of content from the first buffer 212. As such, the computing device 117 may be able to output content from the second buffer 214 while avoiding or minimizing the delay that is typically associated with accessing content stored in a remote (e.g., cloud-based) TSB.

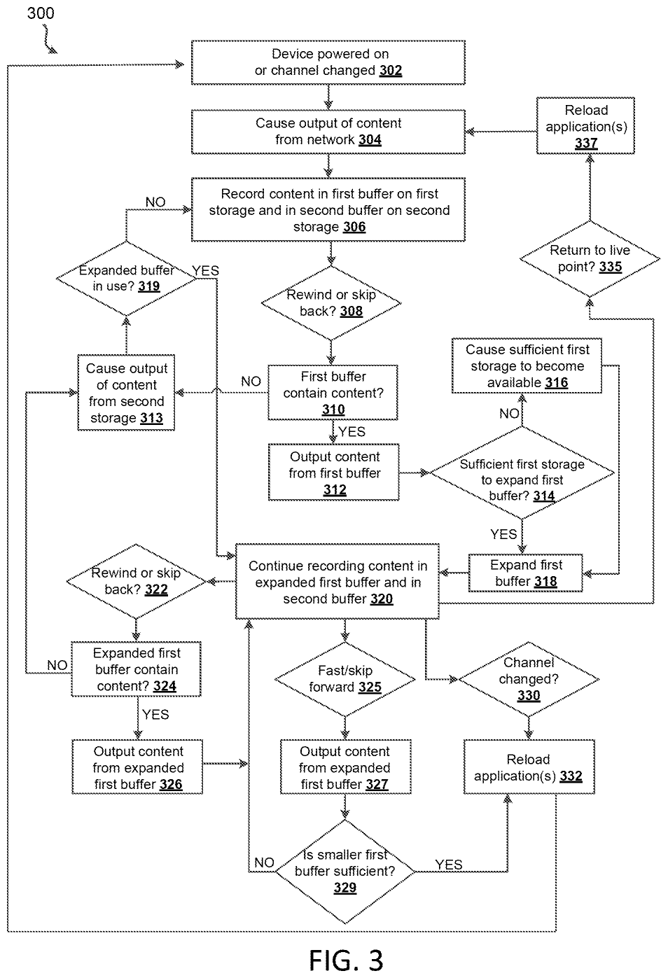

FIG. 3 is an example process 300 for storing content. The process 300 may be performed, for example, by an output device (e.g., the computing device 116). At 302, an output device may be activated. The output device may be activated if it is turned on or powered on. The output device may be activated if a user associated with the output device switches to a new channel. At 304, output of content may be caused (e.g., via a display). The content may comprise an incoming content stream, such as an incoming content stream being delivered by a network (e.g., the network 111).

At 306, the incoming content may be written to or recorded in a first buffer (e.g., local TSB) on a first storage and in a second buffer (e.g., cloud-based TSB) on a second storage. The first storage may be a non-volatile storage medium located on the output device. The second storage may be located remotely from the output device. Writing the content to the first buffer in the first storage may comprise causing storage of a first portion of the content item to the first buffer in the non-volatile storage medium. The amount of available memory in the first storage may be large enough to hold only a limited playback duration of the content item. The first portion of the content item may comprise any playback duration of the content item, such as ten seconds, fifteen seconds, twenty seconds, thirty seconds, etc. of the content item. The stored first portion may be leveraged to provide trick play features during playback.

Writing the content to the second buffer in the second storage may comprise causing storage of at least an additional portion of the content item to the second buffer. The amount of available memory in the second storage may be large enough to hold a larger playback duration (i.e., larger portion) (e.g., ten minutes, thirty minutes, one hour, or more) of the content item than the first storage is able to hold. For example, the amount of available memory in the second storage may be large enough to hold the entire playback duration of the content item. As such, the second buffer may store both the first portion of the content item and the additional portion(s) of the content item. The additional portion(s) of the content item may comprise any playback duration of the content item, such as five minutes, ten minutes, thirty minutes, etc. of the content item. The stored first portion and/or the stored additional portion(s) may be leveraged to provide trick play features during playback.

A user may initiate one or more trick play operations during output of the content item. At 308, a user may initiate a rewind or skip-back operation. The user may initiate a rewind or skip-back operation to a timestamp associated with a frame of the content item. The frame of the content item may occur before the live point of the content item. For example, the user may not understand what an actor in the live content stream said. The user may rewind and/or skip back fifteen seconds behind the live point.

At 310, the computing device may determine if the first buffer contains the content required to perform the rewind or skip-back operation. For example, if the first buffer contains thirty seconds of content and the user rewinds and/or skips back fifteen seconds behind the live point, the computing device may determine that the first buffer contains the content required to perform the rewind or skip-back operation. If the first buffer contains ten seconds of content and the user rewinds and/or skips back fifteen seconds behind the live point, the computing device may determine that the first buffer does not contain the content required to perform the rewind or skip-back operation.

If the first buffer does not contain the content required to perform the rewind or skip-back operation (e.g., if the first buffer does not contain the frame corresponding to the timestamp), the process 300 may proceed to operation 313. At 313, content may be output from the second buffer. Output of the content from the second buffer may be caused based on the timestamp. The content in the second buffer may be output starting from the frame corresponding to the timestamp. For example, if the user rewinds and/or skips back fifteen seconds behind the live point, the content in the second buffer may be output starting from the frame that occurs fifteen seconds behind the live point. The process 300 may return to operation 306 where the incoming content may continue to be written to or recorded in the first buffer on the first storage and in the second buffer on the second storage. For example, the process 300 may return to operation 306 based on (e.g., in response to) determining that an expanded first buffer is not currently in use at operation 319.

Conversely, if the first buffer contains the content required to perform the rewind or skip-back operation (e.g., if the first buffer contains the frame corresponding to the timestamp), the process 300 may proceed to operation 312. At 312, content may be output from the first buffer. Output of the content from the first buffer may be caused based on the timestamp associated with the rewind or skip back. The content in the first buffer may be output starting from the frame corresponding to the timestamp. For example, if the user rewinds and/or skips back fifteen seconds behind the live point, the content in the first buffer may be output starting from the frame that is fifteen seconds behind the live point.

At 314, the computing device may determine if there is sufficient available (e.g., unused) first storage to expand the first buffer. The computing device may determine if there is sufficient available first storage to expand the first buffer based on (e.g., in response to) determining that the first buffer is full (e.g., cannot store any more content). The computing device may determine if there is sufficient available first storage to expand the first buffer based on (e.g., in response to) determining that content is currently being output from the first buffer.

If there is sufficient available (e.g., unused) first storage to expand the first buffer, the process 300 may proceed to operation 318. Conversely, if there is not sufficient available first storage to expand the first buffer the process 300 may proceed to operation 316. At 316, the computing device may cause sufficient first storage to become available. For example, the computing device may try to free up additional memory and increase the first buffer in case the user wishes to skip back or rewind further. The computing device may cause the sufficient amount of memory to become available by unloading at least one application from the first storage. The application(s) may comprise one or more applications that are loaded to the first storage but are not currently in use. The process 300 may proceed to operation 318. At 318, the first buffer may be expanded. The first buffer may be expanded based on (e.g., using) the available (e.g., unused) first storage. The expanded first buffer may be able to store a larger playback duration (i.e., larger portion) of the content item that the initial first buffer. For example, if the initial first buffer was able to store thirty seconds of the content item, the expanded first buffer may be able to store 45 seconds or one minute of the content item.

At 320, the computing device may continue to record content in the expanded first buffer and in the second buffer. The user may initiate one or more additional trick play operations. At 322, the user may initiate an additional (e.g., second) rewind or skip-back operation. For example, the user still may not understand what the actor in the live content stream said. The user may rewind and/or skip back another fifteen seconds to a time stamp that occurs thirty seconds behind the live point.

At 324, the computing device may determine if the expanded first buffer contains the content required to perform the additional rewind or skip-back operation. For example, if the expanded first buffer contains 45 seconds of content and the user has rewinded and/or skipped back to a timestamp that is thirty seconds behind the live point, the computing device may determine that the expanded first buffer contains the content required to perform the additional rewind or skip-back operation. If the expanded first buffer contains twenty seconds of content and the user has rewinded and/or skipped back to a timestamp that is thirty seconds behind the live point, the computing device may determine that the expanded first buffer does not contain the content required to perform the additional rewind or skip-back operation.

If the expanded first buffer does not contain the content required to perform the additional rewind or skip-back operation, the process 300 may proceed back to operation 313, where the content may be output from the second buffer. For example, if the user has rewinded and/or skipped back to a timestamp that is thirty seconds behind the live point, the content in the second buffer may be output starting from the frame that is thirty seconds behind the live point. The process 300 may return to operation 320 where the incoming content may continue to be written to or recorded in the expanded first buffer on the first storage and in the second buffer on the second storage. For example, the process 300 may return to operation 320 based on (e.g., in response to) determining that the expanded first buffer is currently in use at operation 319. If the expanded first buffer becomes full (e.g., cannot store any more content), the computing device may write over the content stored in the expanded first buffer to generate a new first portion of the content item.

Conversely, if the expanded first buffer contains the content required to perform the additional rewind or skip-back operation, the process 300 may proceed to operation 326. At 326, content may be output from the expanded first buffer. Output of the content from the expanded first buffer may be caused based on a timestamp associated with the additional rewind or skip back. The content in the expanded first buffer may be output starting from the frame corresponding to the timestamp associated with the additional rewind or skip back. For example, if the user has rewinded and/or skipped back to a timestamp that is thirty seconds behind the live point, the content in the expanded first buffer may be output starting from the frame that is thirty seconds behind the live point. If the expanded first buffer becomes full (e.g., cannot store any more content), the computing device may write over the content stored in the expanded first buffer to generate a new first portion of the content item. The process 300 may return to operation 320, where the incoming content may continue to be written to or recorded in the expanded first buffer on the first storage and in the second buffer on the second storage

At 325, the user may initiate a fast-forward or skip-forward operation. The user may initiate a fast-forward or skip-forward operation to a timestamp associated with a frame of the content item. The frame of the content item to which the user is fast-forwarding or skipping forward may still occur before the live point of the content item. For example, a user that is viewing the content 45-seconds behind the live stream may fast-forward or skip-forward to a timestamp that is only fifteen seconds behind the live point. At 327, content may be output from the expanded first buffer. Output of the content from the expanded first buffer may be caused based on a timestamp associated with the fast-forward or skip-forward operation. The content in the first buffer may be output starting from the frame corresponding to the timestamp associated with the fast-forward or skip-forward operation. For example, if the user has fast-forwarded or skipped forward to a timestamp that is fifteen seconds behind the live point, the content in the expanded first buffer may be output starting from the frame that is fifteen seconds behind the live point.

At 329, the computing device may determine if a smaller first buffer is sufficient. Determining that a smaller first buffer is sufficient may comprise determine that the first buffer no longer needs to be expanded. The computing device may determine if a smaller first buffer is sufficient based on the timestamp associated with the fast-forward or skip-forward operation. The smaller first buffer may be sufficient if the user has fast-forwarded and/or has skipped far enough ahead that such that the initial, smaller first buffer is sufficient. For example, if the initial first buffer (e.g., the first buffer pre-expansion) was able to store only ten seconds of the content item, and the user has fast-forwarded or skipped forward to a timestamp that is fifteen seconds behind the live point, the computing device may determine that the smaller first buffer is not sufficient. If the smaller first buffer is not sufficient, the process 300 may return to operation 320, where the incoming content may continue to be written to or recorded in the expanded first buffer on the first storage and in the second buffer on the second storage.

Conversely, if the initial first buffer (e.g., the first buffer pre-expansion) was able to store thirty seconds of the content item, and the user has fast-forwarded or skipped forward to a timestamp that is fifteen seconds behind the live point, the computing device may determine that the smaller first buffer is sufficient. If the smaller first buffer is sufficient, the process 300 may proceed to operation 332. At 332, one or more applications may be loaded to the first storage. For example, the application(s) that were unloaded may be reloaded to the first storage. The process 300 may return to operation 306 where the incoming content may continue to be written to or recorded in the first buffer on the first storage and in the second buffer on the second storage.

At 330, the user may change the channel. If the user changes the channel, a smaller first buffer may be sufficient. As such, the process 300 may proceed to operation 332, where the application(s) that were unloaded may be reloaded to the first storage. The process 300 may return to operation 302. At 335, the user may return to the live point. If the user returns to the live point, a smaller first buffer may be sufficient. As such, the process 300 may proceed to operation 337, where the application(s) that were unloaded may be reloaded to the first storage. The process 300 may return to operation 304, where output of the live content stream may be caused.

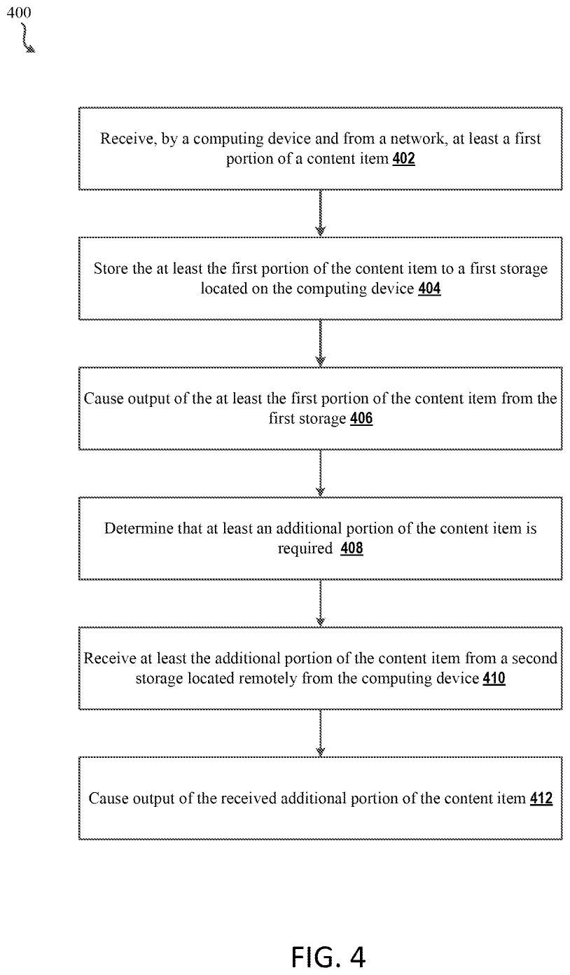

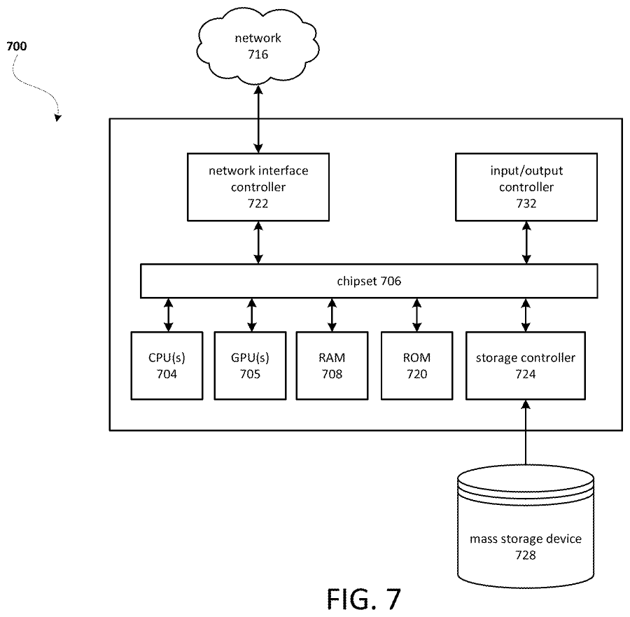

FIG. 4 is an example method 400. The method 400 may comprise a computer implemented method for storing content. A system and/or computing environment, such as the system 100 of FIG. 1 and/or the computing environment of FIG. 7, may be configured to perform the method 400. For example, the computing device 116 of FIG. 1 may be configured to perform the method 400.

At 402, at least a first portion of a content item may be received. The first portion of a content item (e.g., live content stream, linear content stream) may be received by computing device. The first portion of the content item may be received from a network. The computing device may comprise a first storage. The first storage may comprise, for example, a volatile storage medium. The volatile storage medium may comprise random access memory (RAM) or dynamic RAM (DRAM). Alternatively, the first storage may comprise a non-volatile storage medium.

The first storage may be used to provide a first buffer, such as a first TSB, for caching at least a portion (e.g., a playback duration) of the content item. At 404, at least the first portion of the content item may be stored. The first portion of the content item may be stored to the first storage. The first portion of the content item may be stored in the first buffer on the first storage. The first portion of the content item may comprise any playback duration of the content item, such as ten seconds, fifteen seconds, twenty seconds, thirty seconds, etc. of the content item.

The content that is stored in the first buffer of the first storage may be leveraged to perform trick play operation(s). A user may initiate at least one trick play operation. The trick play operation(s) may comprise one or more of a pause operation, a rewind operation, a fast-forward operation, a skip-forward operation, a skip-back operation, or a return-to-live-point operation. For example, trick play operation(s) may comprise multiple rewind operations, a rewind operation and a skip-back operation, a rewind operation and a fast-forward operation, etc.

The first portion of the content item stored in the first buffer 212 may comprise at least some of the content that is required to perform the trick play operation(s). The trick play operation(s) may be at least partially performed using the first portion of the content item stored in the first buffer. Performing the trick play operation(s) may comprise causing output of the first portion of the content item stored in the first buffer. At 406, output of the at least the first portion of the content item from the first storage may be caused. Output of the at least the first portion of the content item may be caused based on the user-initiation of the trick play operation(s).

At 408, it may be determined that at least an additional portion of the content item is required. It may be determined that at least an additional portion of the content item is required to perform the trick play operation(s). For example, it may be determined that the trick play operation(s) comprise a long rewind or skip-back such that the first buffer does not contain all of the content required to perform the longer rewind or skip-back. If the first buffer in the first storage holds only thirty seconds of the content item, and the user rewinds or skip-backs a total of 45 seconds, the first buffer may not contain fifteen seconds of content required to perform the trick play operation(s). A request for at least the additional portion of the content item may be sent, such as to a second storage, based on determining that the additional portion(s) of the content item are required to perform the trick play operation(s). The second storage may be located on the network.

At 410, at least the additional portion of the content item may be received. The additional portion(s) of the content item may be received in response to the request for the additional portion(s) of the content item. The additional portion of the content item may be received from a second buffer. The second buffer may be in a second storage. The second buffer may comprise a TSB. The second buffer may comprise a remote TSB (e.g., cloud-based TSB). The second storage may be located remotely from the computing device. The additional portion(s) of the content item may comprise any playback duration of the content item, such as 30 minutes, one hour, two hours, four hours, eight hours, etc. of the content item.

The additional portion(s) of the content item may be leveraged to perform (or finish performance of) the trick play operation(s). Performing the trick play operation(s) may comprise causing output of the received additional portion(s) of the content item. At 412, output of the received additional portion(s) of the content item may be caused.

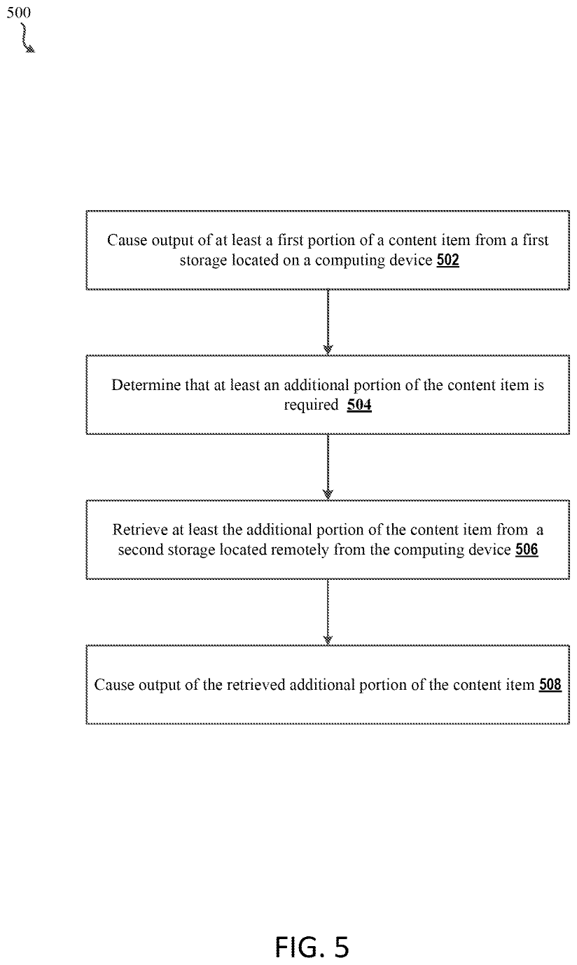

FIG. 5 is an example method 500. The method 500 may comprise a computer implemented method for storing content. A system and/or computing environment, such as the system 100 of FIG. 1 and/or the computing environment of FIG. 7, may be configured to perform the method 500. For example, the computing device 116 of FIG. 1 may be configured to perform the method 500.

A computing device may comprise a first storage. The first storage may comprise, for example, a volatile storage medium. The volatile storage medium may comprise random access memory (RAM) or dynamic RAM (DRAM). Alternatively, the first storage may comprise a non-volatile storage medium. The first storage may comprise a first buffer, such as a first TSB, for caching at least a portion (e.g., a playback duration) of a content item. As a content item (e.g., live content stream, linear content stream) is received by the computing device, such as from a network, at least a first portion of the content item may be stored to the first buffer. The first portion of the content item may comprise any playback duration of the content item, such as ten seconds, fifteen seconds, twenty seconds, thirty seconds, etc. of the content item.

The content that is stored in the first buffer of the first storage may be leveraged to perform trick play operation(s). A user may initiate at least one trick play operation. The trick play operation(s) may comprise one or more of a pause operation, a rewind operation, a fast-forward operation, a skip-forward operation, a skip-back operation, or a return-to-live-point operation. For example, trick play operation(s) may comprise multiple rewind operations, a rewind operation and a skip-back operation, a rewind operation and a fast-forward operation, etc.

The first portion of the content item stored in the first buffer may comprise at least some of the content that is required to perform the trick play operation(s). The trick play operation(s) may be at least partially performed using the first portion of the content item stored in the first buffer. Performing the trick play operation(s) may comprise causing output of the first portion of the content item stored in the first buffer. At 502, output of the at least the first portion of the content item from the first storage may be caused. Output of the at least the first portion of the content item may be caused based on the user-initiation of the trick play operation(s).

At 504, it may be determined that at least an additional portion of the content item is required. It may be determined that at least an additional portion of the content item is required to perform the trick play operation(s). For example, it may be determined that the trick play operation(s) comprise a long rewind or skip-back such that the first buffer does not contain all of the content required to perform the longer rewind or skip-back. If the first buffer in the first storage holds only thirty seconds of the content item, and the user rewinds or skip-backs a total of 45 seconds, the first buffer may not contain fifteen seconds of content required to perform the trick play operation(s). The second storage may be located on the network.

At 506, at least the additional portion of the content item may be retrieved. The additional portion(s) of the content item may be retrieved from a second buffer. The second buffer may be in a second storage. The second buffer may comprise a TSB. The second buffer may comprise a remote TSB (e.g., cloud-based TSB). The second storage may be located remotely from the computing device. The additional portion(s) of the content item may comprise any playback duration of the content item, such as 30 minutes, one hour, two hours, four hours, eight hours, etc. of the content item. The additional portion(s) of the content item may be leveraged to perform (or complete performance of) the trick play operation(s). Performing the trick play operation(s) may comprise causing output of the received additional portion(s) of the content item. At 508, output of the received additional portion(s) of the content item may be caused.

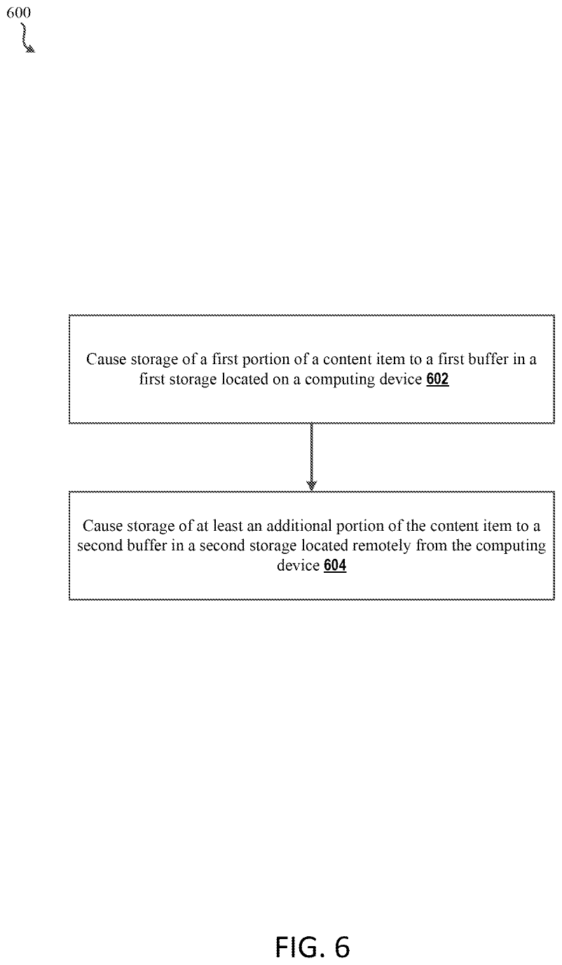

FIG. 6 is an example method 600. The method 600 may comprise a computer implemented method for storing content. A system and/or computing environment, such as the system 100 of FIG. 1 and/or the computing environment of FIG. 7, may be configured to perform the method 600. For example, the network 111 of FIG. 1 may be configured to perform the method 600.

A network may be configured to distribute content to user and/or device locations. For example, the network may be configured to distribute live content streams and/or linear content streams to various devices and/or storages.

At 602, storage of a first portion of a content item may be caused. The first portion of the content item may be stored to a first buffer in a first storage. The first storage may be located on a computing device. The first storage may comprise, for example, a volatile storage medium. The volatile storage medium may comprise random access memory (RAM) or dynamic RAM (DRAM). Alternatively, the first storage may comprise a non-volatile storage medium. The first buffer may comprise a first TSB. Causing the storage of a first portion of a content item may comprise distributing the content to the computing device. The computing device may receive the content and store the first portion of the content item to the first buffer in the first storage. The first portion of the content item may comprise any playback duration of the content item, such as ten seconds, fifteen seconds, twenty seconds, thirty seconds, etc. of the content item.

At 604, storage of at least an additional portion of the content item may be caused. The additional portion(s) of the content item may be stored to a second buffer in a second storage. The second storage may be located remotely from the computing device. The second storage may be configured as network storage, such as cloud storage, accessible by one or more computing devices, such as the computing device. The second storage may be located on the network. The second storage may be separate from the network. The second buffer may comprise a second TSB. The second TSB may comprise a cloud-based TSB. Causing the storage of at least the additional portion(s) of the content item may comprise distributing (e.g., sending) the content to the second storage. The second storage may receive the content and store at least the additional portion(s) of the content item to the second buffer in the second storage. The second portion of the content item may comprise any playback duration of the content item, such as 30 minutes, one hour, two hours, four hours, eight hours, etc. of the content item.

The content that is stored in the first buffer of the first storage and/or the content that is stored in the second buffer of the second storage may be leveraged to perform one or more user-initiated trick play operations. For example, the computing device may be configured to, based on user-initiation of the trick play operation(s), cause output of at least one of the first portion of the content item stored to the first buffer or the additional portion(s) of the content item stored to the second buffer.

A lag time (e.g., delay) may exists between a viewer executing a trick play operation and the computing device accessing and delivering the content stored in the second buffer of the second storage. The lag time may be long enough to negatively impact the content-viewing experience. To avoid this lag time, the content that is stored in the first buffer of the first storage may be leveraged to facilitate quick rewinds and/or skip backs (e.g., to rewatch a play in a sporting event or to try to catch missed dialog). If necessary, the content that is stored in the second buffer of the second storage may still be leveraged to facilitate longer rewinds and/or skip backs.

FIG. 7 is example computing device 700 that may represent any of the various devices or entities shown in FIG. 1, including, for example, central location 110, the streaming servers and/or signal modulators 112, the encoder/transcoder 114, the network 111, the computing device 116, and/or the display 120. That is, the computing device 700 shown in FIG. 7 may be any smartphone, server computer, workstation, access point, router, gateway, tablet computer, laptop computer, notebook computer, desktop computer, personal computer, television, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIG. 1 or any of the methods described in relation to FIGS. 4-6.

The computing device 700 may include a baseboard, or “motherboard,” which is a printed circuit board to which a multitude of components or devices may be connected by way of a system bus or other electrical communication paths. One or more central processing units (CPUs or “processors”) 704 may operate in conjunction with a chipset 706. The CPU(s) 704 may be standard programmable processors that perform arithmetic and logical operations necessary for the operation of the computing device 700.

The CPU(s) 704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 704 may be augmented with or replaced by other processing units, such as GPU(s) 705. The GPU(s) 705 may comprise processing units specialized for but not necessarily limited to highly parallel computations, such as graphics and other visualization-related processing.

A chipset 706 may provide an interface between the CPU(s) 704 and the remainder of the components and devices on the baseboard. The chipset 706 may provide an interface to a random-access memory (RAM) 708 used as the main memory in the computing device 700. The chipset 706 may provide an interface to a computer-readable storage medium, such as a read-only memory (ROM) 720 or non-volatile RAM (NVRAM) (not shown), for storing basic routines that may help to start up the computing device 700 and to transfer information between the various components and devices. ROM 720 or NVRAM may also store other software components necessary for the operation of the computing device 700 in accordance with the aspects described herein.

The computing device 700 may operate in a networked environment using logical connections to remote computing nodes and computer systems of the system 100. The chipset 706 may include functionality for providing network connectivity through a network interface controller (NIC) 722. A NIC 722 may be capable of connecting the computing device 700 to other computing nodes over the system 100. It should be appreciated that multiple NICs 722 may be present in the computing device 700, connecting the computing device to other types of networks and remote computer systems. The NIC may be configured to implement a wired local area network technology, such as IEEE 802.3 (“Ethernet”) or the like. The NIC may also comprise any suitable wireless network interface controller capable of wirelessly connecting and communicating with other devices or computing nodes on the system 100. For example, the NIC 722 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, one or more Bluetooth protocols, and/or the like.

The computing device 700 may be connected to a mass storage device 728 (e.g., first storage 121) that provides non-volatile storage (i.e., memory) for the computer. The mass storage device 728 may store system programs, application programs, other program modules, and data, which have been described in greater detail herein. The mass storage device 728 may be connected to the computing device 700 through a storage controller 724 connected to the chipset 706. The mass storage device 728 may consist of one or more physical storage units. A storage controller 724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 700 may store data on a mass storage device 728 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 728 is characterized as primary or secondary storage and the like.

For example, the computing device 700 may store information to the mass storage device 728 by issuing instructions through a storage controller 724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 may read information from the mass storage device 728 by detecting the physical states or characteristics of one or more particular locations within the physical storage units.

In addition to the mass storage device 728 described herein, the computing device 700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 700.

By way of example and not limitation, computer-readable storage media may include volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 728 depicted in FIG. 7, may store an operating system utilized to control the operation of the computing device 700. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 728 may store other system or application programs and data utilized by the computing device 700.

The mass storage device 728 or other computer-readable storage media may also be encoded with computer-executable instructions, which, when loaded into the computing device 700, transforms the computing device from a general-purpose computing system into a special-purpose computer capable of implementing the aspects described herein. These computer-executable instructions transform the computing device 700 by specifying how the CPU(s) 704 transition between states, as described herein. The computing device 700 may have access to computer-readable storage media storing computer-executable instructions, which, when executed by the computing device 700, may perform the methods described in relation to FIGS. 4-6.

A computing device, such as the computing device 700 depicted in FIG. 7, may also include an input/output controller 732 for receiving and processing input from a number of input devices, such as a keyboard, a mouse, a touchpad, a touch screen, an electronic stylus, or other type of input device. Similarly, an input/output controller 732 may provide output to a display, such as a computer monitor, a flat-panel display, a digital projector, a printer, a plotter, or other type of output device. It will be appreciated that the computing device 700 may not include all of the components shown in FIG. 7, may include other components that are not explicitly shown in FIG. 7, or may utilize an architecture completely different than that shown in FIG. 7.

As described herein, a computing device may be a physical computing device, such as the computing device 700 of FIG. 7. A computing device may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes, from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey data indicating a preferred or ideal embodiment. “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described above with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are shown as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the shown computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

1. A method comprising:
receiving, by a computing device and from a network, at least a first portion of a content item;
storing the at least the first portion of the content item to a first buffer in a first storage, wherein the first storage is located on the computing device;
based on user-initiation of at least one trick play operation, causing output of the at least the first portion of the content item from the first buffer;
determining, during output of the at least the first portion of the content item from the first buffer, that at least an additional portion of the content item is required to perform the at least one trick play operation;
receiving at least the additional portion of the content item from a second buffer in a second storage located remotely from the computing device; and
causing output of the received additional portion of the content item.

2. The method of claim 1, wherein the first buffer comprises a time-shift buffer (TSB), and the second buffer comprises a cloud-based TSB.

3. The method of claim 1, further comprising:
sending a request for at least the additional portion of the content item to the second storage based on determining that at least the additional portion of the content item is required to perform the at least one trick play operation.

4. The method of claim 1, wherein the first storage comprises a volatile storage.

5. The method of claim 1, wherein the second storage is located on the network.

6. The method of claim 1, wherein the computing device comprises one or more of a set-top box, a television, a display device, a computer, a smartphone, a laptop, a tablet, a multimedia playback device, or a portable electronic device.

7. The method of claim 1, wherein the at least one trick play operation comprises one or more of a pause operation, a rewind operation, a fast-forward operation, a skip-forward operation, a skip-back operation, or a return-to-live-point operation.

8. The method of claim 1, wherein the content item comprises a linear content item.

9. A method comprising:
based on user-initiation of at least one trick play operation, causing output of at least a first portion of a content item from a first buffer in a first storage, wherein the first storage is located on a computing device;
determining, during output of the at least the first portion of the content item from the first buffer, that at least an additional portion of the content item is required to perform the at least one trick play operation; and
retrieving at least the additional portion of the content item from a second buffer in a second storage located remotely from the computing device; and
causing output of the retrieved additional portion of the content item.

10. The method of claim 9, wherein the first buffer comprises a time-shift buffer (TSB), and the second buffer comprises a cloud-based TSB.

11. The method of claim 9 wherein the first storage comprises a volatile storage.

12. The method of claim 9, wherein the computing device comprises one or more of a set-top box, a television, a display device, a computer, a smartphone, a laptop, a tablet, a multimedia playback device, or a portable electronic device.

13. The method of claim 9, wherein the at least one trick play operation comprises one or more of a pause operation, a rewind operation, a fast-forward operation, a skip-forward operation, a skip-back operation, or a return-to-live-point operation.

14. The method of claim 9, wherein the content item comprises a linear content item.

15. A method comprising:
causing storage of a first portion of a content item to a first buffer in a first storage, the first storage located on a computing device;
causing storage of at least an additional portion of the content item to a second buffer in a second storage, wherein the second storage is located on a network located remotely from the computing device;
wherein the computing device is configured to, based on user-initiation of at least one trick play operation, cause output of the first portion of the content item stored to the first buffer and the additional portion of the content item stored to the second buffer.

16. The method of claim 15, wherein the first buffer comprises a time-shift buffer (TSB), and the second buffer comprises a cloud-based TSB.

17. The method of claim 15, wherein the first storage comprises a volatile storage.

18. The method of claim 15, wherein the computing device comprises one or more of a set-top box, a television, a display device, a computer, a smartphone, a laptop, a tablet, a multimedia playback device, or a portable electronic device.

19. The method of claim 15, wherein the at least one trick play operation comprises one or more of a pause operation, a rewind operation, a fast-forward operation, a skip-forward operation, a skip-back operation, or a return-to-live-point operation.

20. The method of claim 15, wherein the content item comprises a linear content item.
